(19) United States
(12) Patent Application Publication
(10) Pub. No.: US 2016/0055883 A1
(43) Pub. Date: Feb. 25, 2016

(54) Methods and Apparatus for Automatic Editing of Video Recorded by an Unmanned Aerial Vehicle

(71) Applicant: CAPE PRODUCTIONS INC., Redwood City, CA (US)

(72) Inventors: Jason Soll, Mountain View, CA (US); Thomas Finsterbusch, Mountain View, CA (US); Louis Gresham, San Mateo, CA (US); Mark Murphy, Redwood City, CA (US); Gabriel Charalambides, Redwood City, CA (US); Alexander Loo, Redwood City, CA (US)

(73) Assignee: CAPE PRODUCTIONS INC., Redwood City, CA (US)

(21) Appl. No.: 14/832,980

(22) Filed: Aug. 21, 2015

Related U.S. Application Data
(60) Provisional application No. 62/041,009, filed on Aug. 22, 2014.
(60) Provisional application No. 62/064,434, filed on Oct. 15, 2014.

(51) Int. Cl. G11B 27/031; H04N 5/77; H04N 7/18; G11B 27/13

(52) U.S. Cl. CPC G11B 27/031; G11B 27/13; H04N 5/77; H04N 7/185

(57) ABSTRACT

In some embodiments, an apparatus includes a processor and a memory. The memory is connected to the processor and stores instructions executed by the processor to receive a video segment of a moving object recorded by an Unmanned Aerial Vehicle (UAV). The memory also stores instructions executed by the processor to receive a measured moving object parameter and edit the video segment of the moving object based on the measured moving object parameter to form an edited video segment. The memory stores instructions executed by the processor to send the edited video segment.

### CROSS-REFERENCE TO RELATED APPLICATION

This application claims priority to U.S. Provisional Patent Application Ser. No. 62/041,009, filed on Aug. 22, 2014, and U.S. Provisional Patent Application Ser. No. 62/064,434, filed on Oct. 15, 2014. The contents of the aforementioned applications are incorporated herein by reference in their entirety.

The contents of a related application Ser No. ______, filed on Aug. 21, 2015, entitled “Methods and Apparatus for Unmanned Aerial Vehicle Autonomous Aviation”, (Attorney Docket No. CAPE-001/02US 322555-2003) are incorporated herein by reference in its entirety.

### FIELD OF THE INVENTION

Some embodiments described herein relate generally to methods and apparatus for unmanned aerial vehicle enabled video recording. In particular, but not by way of limitation, some embodiments described herein relate to methods and apparatus for Unmanned Aerial Vehicles (UAVs) enabled automatic video editing.

### BACKGROUND

An Unmanned Aerial Vehicle (UAV) (also referred to herein as a drone) is an aircraft without a human pilot on board. Its flight is often controlled either autonomously by computers or by the remote control of a human on the ground. Drones have been used for keeping a skier in a frame of a camera while the skier travels along a ski path. Video recorded by drones during such sporting activities often include segments that are less interesting. For example, when a skier is preparing to ski but has not moved yet, the drone may have already started recording the video. Such video segments are of little interests but an accumulation of such uninteresting video segments can needlessly consume server and network bandwidth resources.

Accordingly, a need exists for methods and apparatus for Unmanned Aerial Vehicles (UAVs) enabled automatic video editing.

### SUMMARY

In some embodiments, an apparatus includes a processor and a memory. The memory is connected to the processor and stores instructions executed by the processor to receive a video segment of a moving object recorded by an Unmanned Aerial Vehicle (UAV). The memory also stores instructions executed by the processor to receive a measured moving object parameter and edit the video segment of the moving object based on the measured moving object parameter to form an edited video segment. The memory stores instructions executed by the processor to send the edited video segment.

### BRIEF DESCRIPTION OF THE DRAWINGS

FIG. 1 is a diagram illustrating a drone enabled video recording system, according to an embodiment.

FIG. 2 is a diagram illustrating functions of the wearable device 102, according to an embodiment.

FIGS. 3-4 are diagrams illustrating physical structures of the wearable device 102, according to an embodiment.

FIG. 5 is a block diagram illustrating an UAV video editor, according to an embodiment.

FIG. 6 is a diagram illustrating an example of UAV automatic video editing, according to an embodiment.

FIG. 7 is a flow chart illustrating a method of UAV automatic video editing, according to an embodiment.

FIG. 8 is a diagram illustrating video footage downsampling, according to an embodiment.

FIG. 9 is a diagram illustrating a video capture and editing optimization, according to an embodiment.

### DETAILED DESCRIPTION

In some embodiments, an apparatus includes a processor and a memory. The memory is connected to the processor and stores instructions executed by the processor to receive a video segment of a moving object recorded by an Unmanned Aerial Vehicle (UAV). The memory also stores instructions executed by the processor to receive a measured moving object parameter and edit the video segment of the moving object based on the measured moving object parameter to form an edited video segment. The memory stores instructions executed by the processor to send the edited video segment.

As used in this specification, the singular forms “a,” “an” and “the” include plural referents unless the context clearly dictates otherwise. Thus, for example, the term “a moving object” is intended to mean a single moving object or a combination of moving objects.

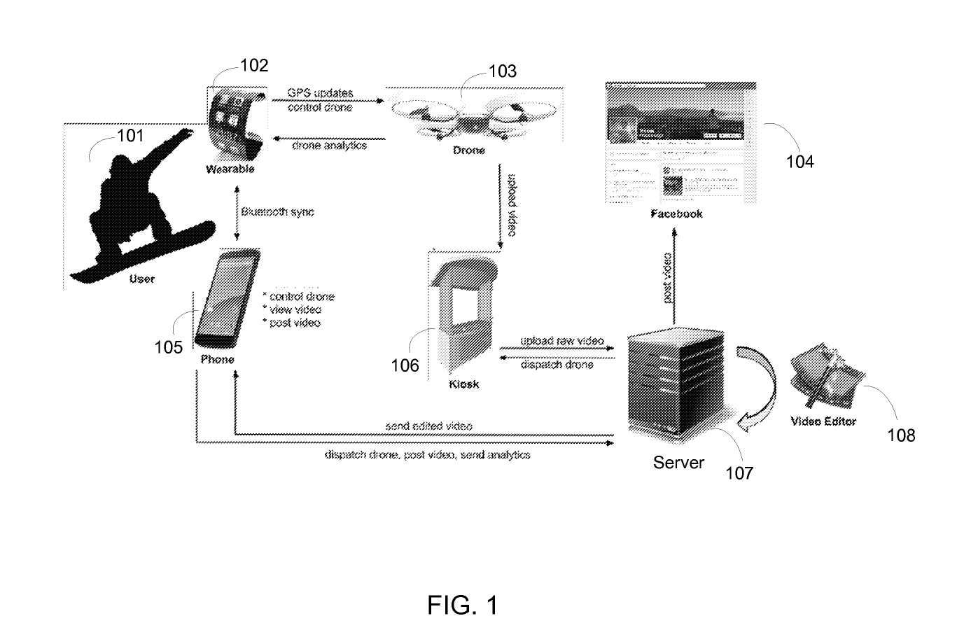

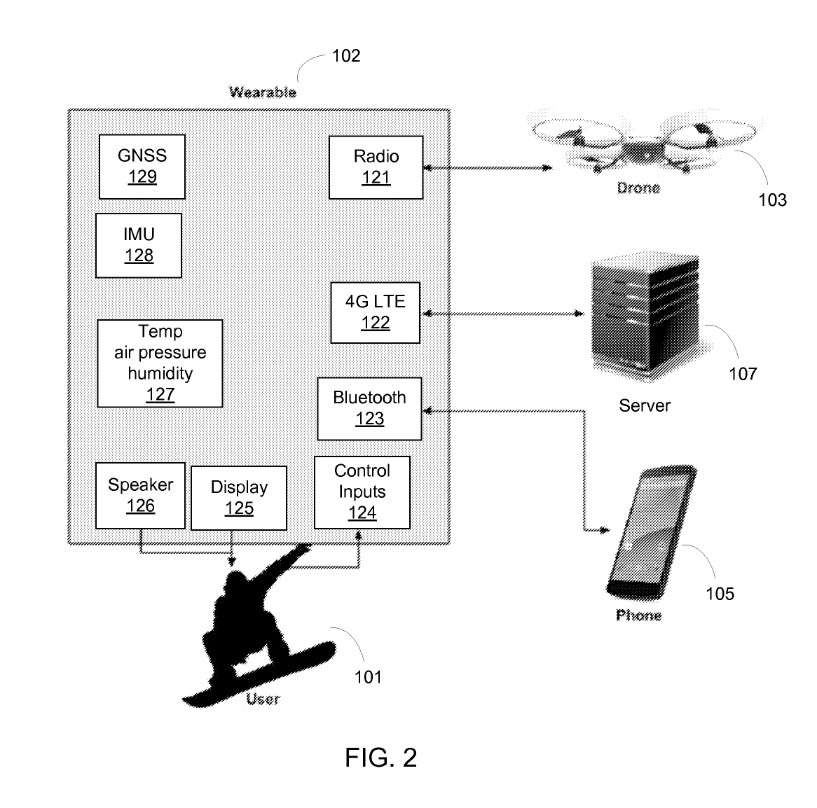

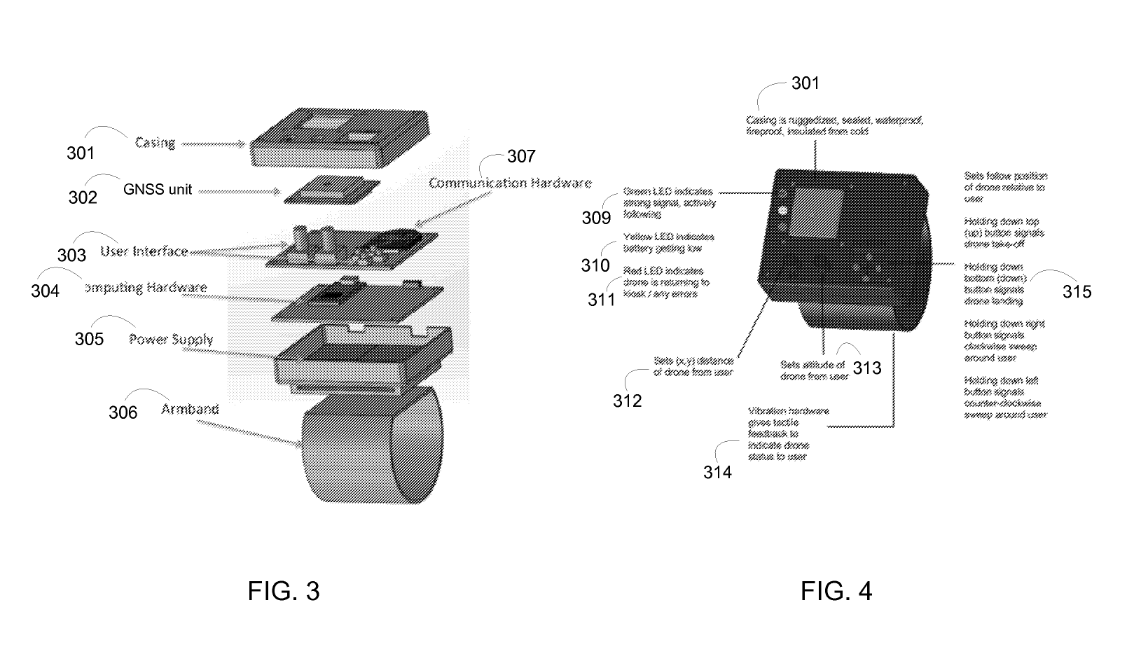

FIG. 1 is a diagram illustrating a drone enabled video recording system, according to an embodiment. In some embodiments, a moving object 101 (also referred herein to as a user) (e.g., a snowboarder in this figure) has a wearable device 102 which can be configured to send Global Navigation Satellite System (GNSS) updates of the moving object to a drone 103. The drone 103 actively tracks the position of the moving object to keep the moving object in a frame of a camera attached to the drone such that a video of the moving object can be recorded during a sporting activity. The wearable device 102 can also be configured to control the drone. For example, the wearable device can control the launch/land, flight route, and/or video recording of the drone. The analytics of the drone (e.g., location coordinates, altitude, flight duration, video recording duration, etc.) can be sent from the drone to the wearable device. The communication medium between the drone and the wearable device can be via radio waves, as illustrated in FIG. 2. Details of the physical structure of the wearable device 102 are described herein in FIGS. 3-4.

In one embodiment, a mobile device 105 associated with the moving object can communicate with the wearable device via Bluetooth. In addition, the mobile device 105 can be used to control the drone, view and/or share recorded videos. A kiosk 106, which can be disposed locally at the sporting activity site, can receive the video recorded by the drone and upload the video to a server 107. The server 107 can communicate with a video editor 108 and/or video sharing websites 104 for post-editing and sharing.

FIG. 2 is a diagram illustrating functions of the wearable device 102, according to an embodiment. In some embodiments, the wearable device 102 can include a GNSS navigation system 129 which provides locations of the moving object 101. The wearable device 102 can include a magnetometer and/or a compass for navigation and orientation. The wearable device 102 can also include an Inertial Measurement Unit (IMU) 128 which provides velocities, orientations, and/or gravitational forces of the moving object 101. The wearable device 102 can also include other devices to measure and provide temperature, pressure, and/or humidity 127 of the environment that the moving object is in. The wearable device 102 can include a speaker 126 to communicate with the moving object 101. The wearable device 102 can also include a microphone (not shown in FIG. 2) which can record audio clips of the moving object. The audio clips can be used later in the process for automatic video editing.

The wearable device 102 may also include a display device for the user to view analytics associated with the user and/or analytics associated with the drone. The analytics may include location, altitude, temperature, pressure, humidity, date, time, and/or flight route. In some instances, the display device can also be used to view the recorded video. A control inputs unit 124 can be included in the wearable device 102 to allow the user to provide control commands to the wearable device or to the drone. As discussed above with regards to FIG. 1, in some embodiments, the wearable device can communicate to the mobile device 105 via Bluetooth circuit 123, to the server 107 via 4G Long Term Evolution (LTE) circuit 122, and to the drone via radio circuit 121. In some embodiments, the wearable device can communicate to the mobile device 105 via other communication mechanisms, such as, but not limited to, long-range radios, cell tower (3G and/or 4G), WiFi (e.g., IEEE 802.11), Bluetooth (Bluetooth Low Energy or normal Bluetooth), and/or the like.

In some embodiments, the wearable device 102 can be configured to communicate with the drone in order to update it about the user's current position and velocity vector. In some embodiments, the wearable device 102 can be configured to communicate with the backend server to log the status of a user. In some embodiments, the wearable device 102 can be configured to communicate with user's phone to interact with a smartphone app. In some embodiments, the wearable device 102 can be configured to give a user the ability to control the drone via buttons. In some embodiments, the wearable device 102 can be configured to give a user insight into system status via audio output, graphical display, LEDs, etc. In some embodiments, the wearable device 102 can be configured to measure environmental conditions (temperature, wind speeds, humidity, etc.)

In some embodiments, the wearable device is a piece of hardware worn by the user. Its primary purpose is to notify the drone of the user's position, thus enabling the drone to follow the user and to keep the user in the camera frame.

FIGS. 3-4 are diagrams illustrating physical structures of the wearable device 102, according to an embodiment. In some embodiments, the wearable device 102 can include a casing 301, a GNSS unit 302, a user interface 303, computing hardware 304, communication hardware 307, a power supply 305, and an armband 306. The face of the wearable device can include a ruggedized, sealed, waterproof, and fireproof casing 301 which is insulated from cold. The face of the wearable device can also include a green LED 309 which indicates that the drone is actively following the user. A yellow LED 310 can indicate that the battery of the drone is running low. A red LED 311 can indicate that the drone is returning to kiosk and/or there is error. The knob 312 can set (x,y) distance of the drone from the user. Knob 313 can set altitude of the drone. The wearable device can include vibration hardware 314 which gives tactile feedback to indicate drone status to the user. Buttons 315 can set a follow mode of the drone relative to the user. For example, holding down an up button initiates drone take-off, holding down a down button initiates drone landing. Holding down a right button initiates a clockwise sweep around a user. Holding down left button initiates a counter clockwise sweep around the user.

In some embodiments, the wearable device can be in a helmet, a wristband, embedding in clothing (e.g., jackets, boots, etc.), embedded in sports equipment (snowboard, surfboard, etc.), and/or embedded in accessories (e.g., goggles, glasses, etc.).

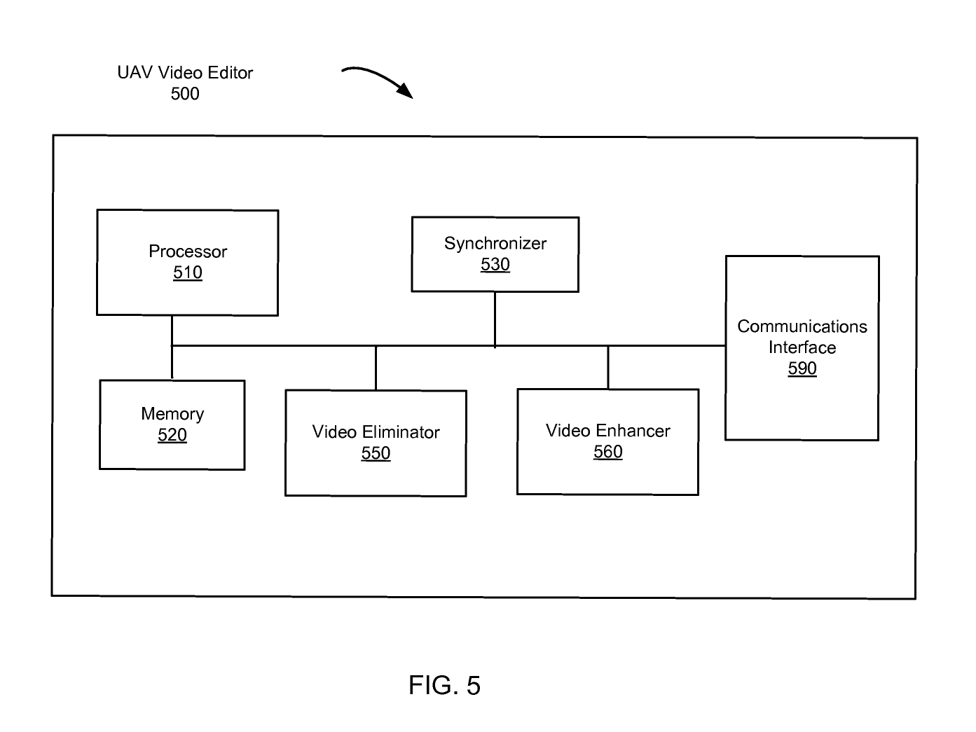

FIG. 5 is a block diagram illustrating an UAV video editor 500, according to an embodiment. The UAV video editor 500 can be configured to automatically edit a video segment recorded by the UAV based on metadata (i.e., measured moving object parameters) about a user (or a moving object), the drone, the environment that the user and the drone are in, and/or the captured video footage. The UAV video editor 500 can be configured to automatically identify a video's highlight moments based on the metadata. The UAV video editor 500 can be hardware and/or software (stored and/or executing in hardware), operatively coupled to the UAV. In other embodiments, the UAV video editor 500 can be hardware and/or software (stored and/or executing in hardware), operatively coupled to a remote server, and/or the like.

In some embodiments, the UAV video editor 500 includes a processor 510, a memory 520, a communications interface 590, a synchronizer 530, a video eliminator 550, and a video enhancer 560. In some embodiments, the UAV video editor 500 can be a single physical device. In other embodiments, the UAV video editor 500 can include multiple physical devices (e.g., operatively coupled by a network), each of which can include one or multiple modules and/or components shown in FIG. 5.

Each module or component in the UAV video editor 500 can be operatively coupled to each remaining module and/or component. Each module and/or component in the UAV video editor 500 can be any combination of hardware and/or software (stored and/or executing in hardware) capable of performing one or more specific functions associated with that module and/or component.

The memory 520 can be, for example, a random-access memory (RAM) (e.g., a dynamic RAM, a static RAM), a flash memory, a removable memory, a hard drive, a database and/or so forth. In some embodiments, the memory 520 can include, for example, a database, process, application, virtual machine, and/or some other software modules (stored and/or executing in hardware) or hardware modules configured to execute a UAV automatic video editing process and/or one or more associated methods for UAV automatic video editing. In such embodiments, instructions of executing the UAV automatic video process and/or the associated methods can be stored within the memory 520 and can be executed at the processor 510.

The communications interface 590 can include and/or be configured to manage one or multiple ports of the UAV video editor 500. In some embodiments, the communications interface 590 can be configured to, among other functions, receive data and/or information, and send commands, and/or instructions, to and from various devices including, but not limited to, the drone, the wearable device, the mobile device, the kiosk, the server, and/or the world wide web.

The processor 510 can be configured to control, for example, the operations of the communications interface 590, write data into and read data from the memory 520, and execute the instructions stored within the memory 520. The processor 510 can also be configured to execute and/or control, for example, the synchronizer 530, the video eliminator 550, and the video enhancer 560, as described in further detail herein. In some embodiments, under the control of the processor 510 and based on the methods or processes stored within the memory 520, the synchronizer 530, the video eliminator 550, and the video enhancer 560 can be configured to execute a UAV automatic video editing process, as described in further detail herein.

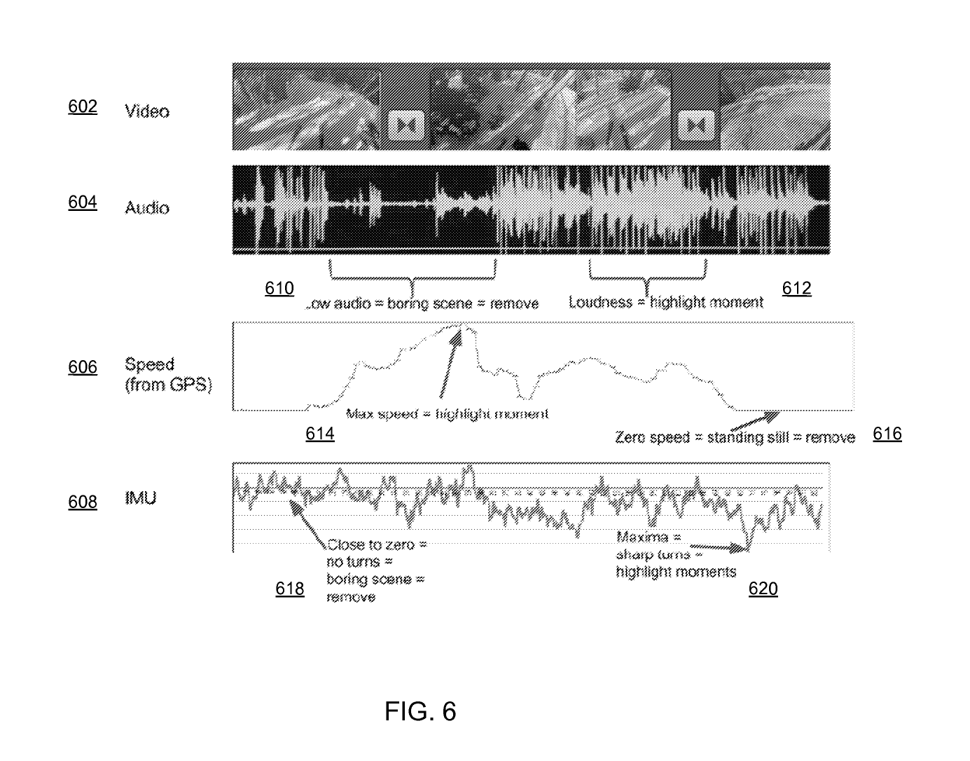

The synchronizer 530 can be any hardware and/or software module (stored in a memory such as the memory 520 and/or executing in hardware such as the processor 510) configured to synchronize a video segment (also referred to herein as a video clip, a video track, a video snippet, or a video footage) with a measured moving object parameter. The measured moving object parameter can be selected from a velocity vector, a gravitational force value, an audio clip, compass readings, magnetometer readings, barometer readings, altitude readings, an analysis of the recorded video itself (for instance, with various computer vision approaches, the processor 510 can be configured to determine that the moving subject which is being filmed by the UAV is not in the frame of the video. In such circumstance, this video section can be automatically removed because it is uninteresting), and/or the like. For example, as shown in FIG. 6, the UAV video editor 500 receives a 10 minute video clip 602 of a user snowboarding down a hill. In addition, the UAV video editor also receives a 10 minute audio clip 604 from the wearable device that recorded what the user heard/said at that time. Moreover, the user's speed 606 can be received from the GNSS receiver, and the inertial measurements 608 can be received from the IMU. The synchronizer 530 synchronizes the audio clip 604, the speed 606, and the IMU 608 with the video clip 602 and provides the synchronized results to the video eliminator 550.

The video eliminator 550, as shown in FIG. 5, can be any hardware and/or software module (stored in a memory such as the memory 520 and/or executing in hardware such as the processor 510) configured to eliminate certain sections from the video clip 602, as shown in FIG. 6, based on the synchronized results from the synchronizer 530. For example, when a loud audio section 612 (e.g., screaming or crashing) is identified from the audio clip 604, it can be a highlight moment of the skier's trip down the hill. Therefore, the video eliminator 550 does not eliminate the corresponding section in the video clip 602. When a low audio section 610 (e.g., prior to start the trip or after the completion of the trip) is identified from the audio clip 604, it probably represents an uninteresting moment of the skier's trip down the hill. Therefore, the video eliminator 550 can eliminate the corresponding section in the video clip 602. For another example, when the GNSS readings 606 indicate the user is reaching very high speeds 614, the corresponding video sections can be regarded as a highlight moment and the video eliminator 550 does not eliminate the corresponding section in the video clip 602. Conversely, when the user is stationary 616 (i.e. substantially close to zero speed), the video sections are most likely uninteresting. The video eliminator 550 can eliminate the corresponding section in the video clip 602 automatically. Likewise, the inertial measurement unit (IMU) 608 that is carried by the user via the wearable device gives readings of the gravitational forces the user experiences. High readings of the IMU 620 indicate sharp turns taken by the user. The sharpest turns can again be automatically identified as highlight moments. Therefore the video eliminator 550 does not eliminate the corresponding section in the video clip 602. The video eliminator 550 can eliminate the corresponding section in the video clip 602 when low readings of the IMU 618 are identified.

The video enhancer 560, as shown in FIG. 5, can be any hardware and/or software module (stored in a memory such as the memory 520 and/or executing in hardware such as the processor 510) configured to automatically enhance the edited video from the video eliminator 550. For example, once the video eliminator 550 removed the video sections that are less interesting, the video enhancer can be configured to add text to the video (such as the skier's name, date of the ski trip), and/or add music and/or animations to the video.

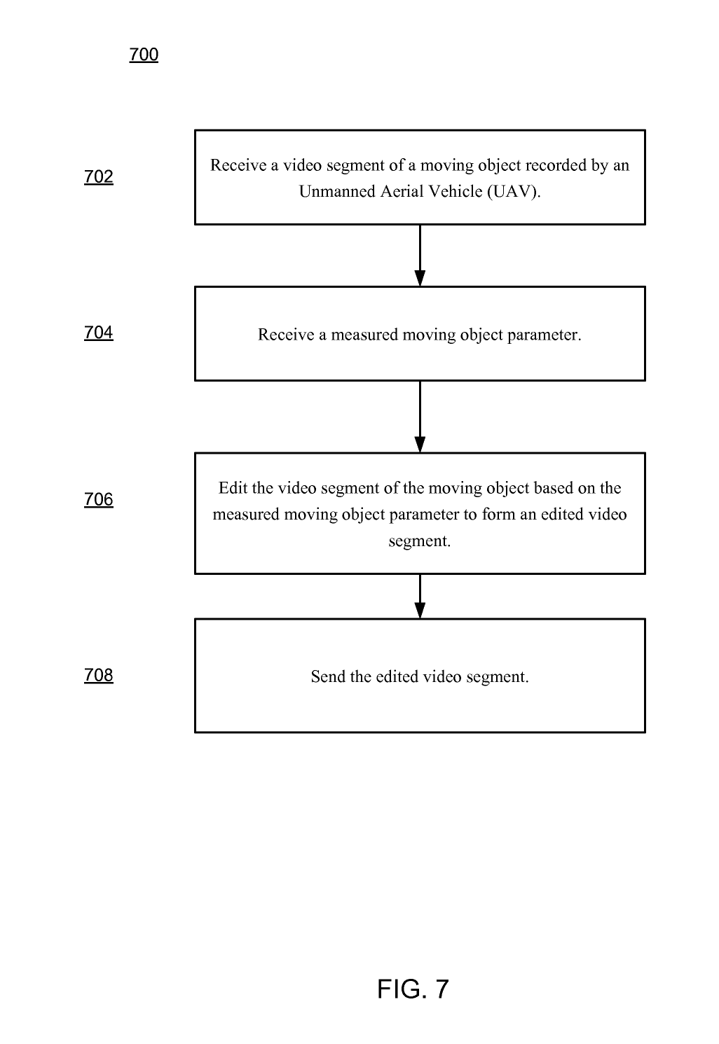

FIG. 7 is a flow chart illustrating a method for automatically editing a video segment recorded by a UAV. The automatic video editing method 500 can be executed at, for example, a UAV video editor such as the UAV video editor 500 shown and described with respect to FIG. 5. The method includes receiving a video segment of a moving object recorded by an UAV at 702 and receiving a measured moving object parameter 704. For example, the measured moving object parameter may include a velocity vector, a gravitational force value and/or an audio clip. The method further includes editing the video segment of the moving object based on the measured moving object parameter to form an edited video segment at 706. For example, this may involve synchronizing a video segment with a measured moving object parameter and removing sections from the video segment that are less interesting (e.g., low speed, low audio, no turns of a moving object). The method further includes sending the edited video segment at 708. For example, this may involve sending the edited video segment to an email address associated with the moving object, to an app in a mobile device, sharing it on social media, and/or sending the edited video segment to another server for further editing.

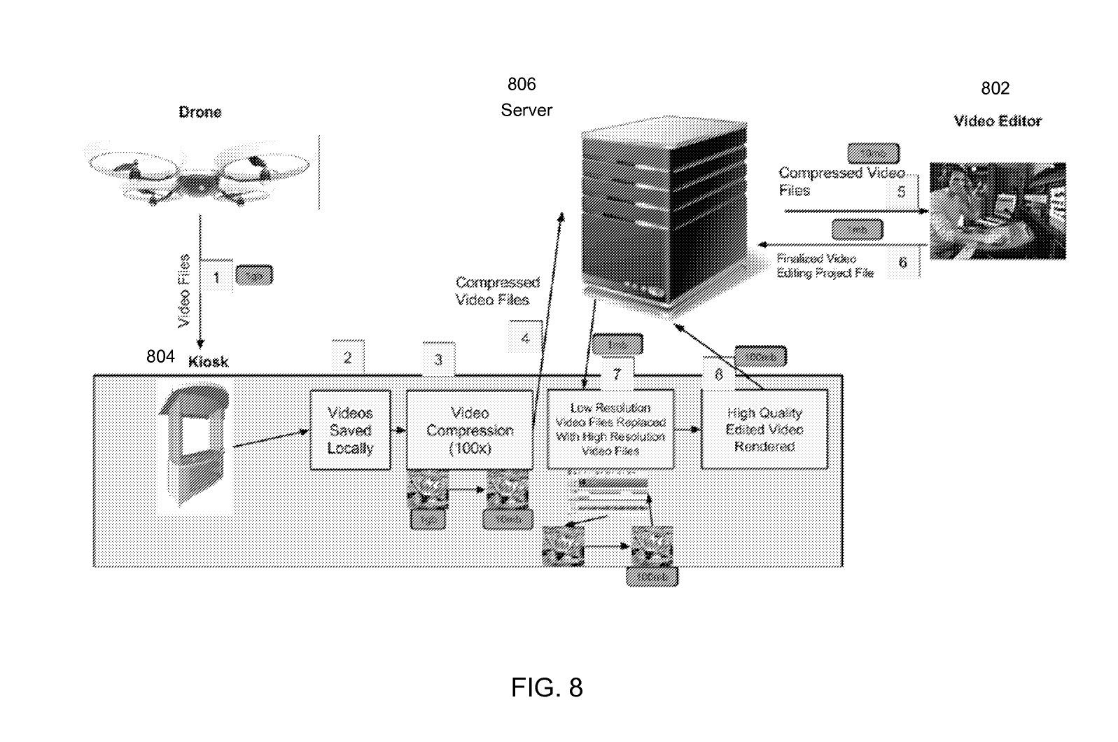

FIG. 8 is a diagram illustrating a method of video footage downsampling to enhance video file upload and/or download speeds for human video editors such that rapid turnaround time for the user to receive the final video product can be achieved, according to an embodiment. In some embodiments, the human video editors 802 receive low resolution, compressed video files to edit the video. The human video editors 802 then send the project file back to a kiosk 804, where corresponding high resolution files are stored. The project file in the low resolution may then be used to edit the high resolution files. The final video may be sent to the server 806. This method of video footage downsampling can be implemented automatically.

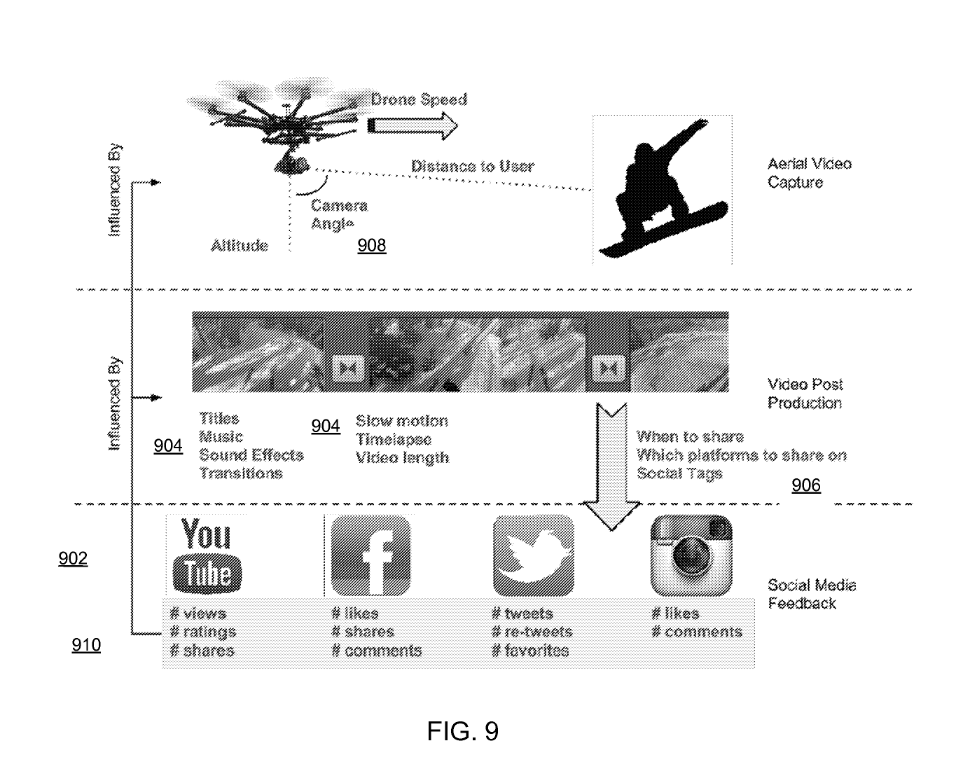

FIG. 9 is a diagram illustrating a video capture and editing optimization for various social media and video distribution goals, according to an embodiment. Variables 908 that determine how the drone captures a video of a user can include, the distance at which the drone follows the user, the angle of the camera, the speed of the drone, and the like. In addition, once the video segment is captured, editing decisions can be made. For example, the editing decisions 904 can include the length of the video, the number of video segments, the music to add to the video, which video sections are less interesting and can be removed, which video sections can be slowed down or sped up, and the like. Once a video is produced, options to distribute the video 906 can include, for example, which website and/or social media to post the video to (such as YouTube®, Facebook®, Twitter®, Instagram® or others) 902.

In some embodiments, the above mentioned parameters (such as 904 and 906) can be learned by analyzing video metrics after the videos are posted on the various social media outlets. For example, the video metrics 910 can include how many views a YouTube® video has received, how many Facebook® likes the post containing the video received, how many times a video has been tweeted, and the like. The video metrics can be input to a machine learning process to learn how the parameters (such as 904 and 906) can be adjusted to increase the video metrics. In other words, a feedback loop is created such that how the drone flies and how the video is edited can be impacted by how well the output video does on social media.

An embodiment of the present invention relates to a computer storage product with a non-transitory computer readable storage medium having computer code thereon for performing various computer-implemented operations. The media and computer code may be those specially designed and constructed for the purposes of the present invention, or they may be of the kind well known and available to those having skill in the computer software arts. Examples of computer-readable media include, but are not limited to: magnetic media, optical media, magneto-optical media and hardware devices that are specially configured to store and execute program code, such as application-specific integrated circuits (“ASICs”), programmable logic devices (“PLDs”) and ROM and RAM devices. Examples of computer code include machine code, such as produced by a compiler, and files containing higher-level code that are executed by a computer using an interpreter. For example, an embodiment of the invention may be implemented using JAVA@, C++, or other object-oriented programming language and development tools. Another embodiment of the invention may be implemented in hardwired circuitry in place of, or in combination with, machine-executable software instructions.

The foregoing description, for purposes of explanation, used specific nomenclature to provide a thorough understanding of the invention. However, it will be apparent to one skilled in the art that specific details are not required in order to practice the invention. Thus, the foregoing descriptions of specific embodiments of the invention are presented for purposes of illustration and description. They are not intended to be exhaustive or to limit the invention to the precise forms disclosed; obviously, many modifications and variations are possible in view of the above teachings. The embodiments were chosen and described in order to best explain the principles of the invention and its practical applications, they thereby enable others skilled in the art to best utilize the invention and various embodiments with various modifications as are suited to the particular use contemplated. It is intended that the following claims and their equivalents define the scope of the invention.

What is claimed is:

1. An apparatus, comprising:
a processor; and
a memory connected to the processor, the memory storing instructions executed by the processor to:
receive a video segment of a moving object recorded by an Unmanned Aerial Vehicle (UAV);
receive a measured moving object parameter;
edit the video segment of the moving object based on the measured moving object parameter to form an edited video segment;
send the edited video segment.

2. The apparatus of claim 1, wherein the measured moving object parameter is selected from a velocity vector, a gravitational force value, an audio clip, a compass reading, a magnetometer reading, a barometer reading, an altitude reading, and an analysis of the video segment.

3. The apparatus of claim 1, wherein the memory stores instructions executed by the processor to:
eliminate video from the video segment of the moving object based on the measured moving object parameter.

4. The apparatus of claim 1, wherein the measured moving object parameter includes velocity vectors, the memory storing instructions executed by the processor to eliminate video corresponding to relatively slow velocity vectors.

5. The apparatus of claim 1, wherein the measured moving object parameter includes gravitational force values, the memory storing instructions executed by the processor to eliminate video corresponding to relatively low gravitational force values.

6. The apparatus of claim 1, wherein measured moving object parameter includes an audio clip, the memory storing instructions executed by the processor to eliminate video corresponding to relatively low volume audio clip segments.
